(19) United States
(12) Patent Application Publication
(10) Pub. No.: US 2023/0203720 A1
(43) Pub. Date: Jun. 29, 2023

(54) FABRIC AND MANUFACTURING METHOD THEREOF

(71) Applicant: TAYA CANVAS (SHANGHAI) COMPANY LTD, Shanghai (CN)

(72) Inventor: I-Chien Lin, Shanghai (CN)

(73) Assignee: TAYA CANVAS (SHANGHAI) COMPANY LTD, Shanghai (CN)

(21) Appl. No.: 17/696,837

(22) Filed: Mar. 16, 2022

(30) Foreign Application Priority Data
Dec. 24, 2021 (CN) 202111601962.9

(51) Int. Cl. D03D 13/00; D03D 15/54; G09F 13/04

(52) U.S. Cl. CPC D03D 13/004; D03D 15/54; G09F 13/04

(57) ABSTRACT

The disclosure provides a fabric suitable for an inner light cloth of advertisements. The fabric includes a yarn woven into the fabric with a whiteness of at least greater than 90%, in which the yarn is composed of fibers made from a white masterbatch. A manufacturing method of a fabric suitable for an inner light cloth of advertisements is also provided.

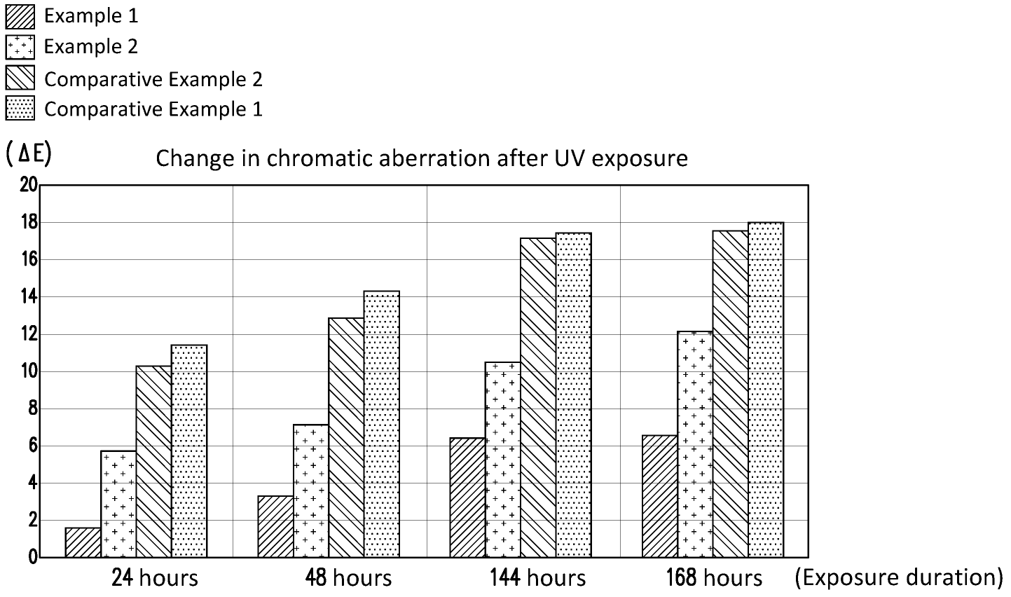

### CROSS-REFERENCE TO RELATED APPLICATION

This application claims the priority benefit of China application serial no. 202111601962.9, filed on Dec. 24, 2021. The entirety of the above-mentioned patent application is hereby incorporated by reference herein and made a part of this specification.

### BACKGROUND

### TECHNICAL FIELD

The disclosure relates to a fabric and a manufacturing method thereof, and in particular relates to a fabric suitable for an inner light cloth of advertisements and a manufacturing method thereof.

### DESCRIPTION OF RELATED ART

Generally speaking, a light box cloth of advertisements can be divided into an inner light cloth and an outer light cloth, and the requirements for the aforementioned two kinds of cloths are different according to product requirements. For example, for an inner light cloth used in a light box cloth of advertisements, by increasing the amount of light (lighting method), colors printed on the cloth become relatively vivid, thereby improving the viewer’s visual experience and achieving the advertising effect. The light transmittance and color presented by the inner light cloth of advertisements depend on the whiteness of a fabric, and that is to say, the higher the whiteness of the fabric, the better the color can be presented on the inner light cloth. Thus, a fabric of an inner light cloth of advertisements is required to have a certain degree of whiteness (degree of white). On the other hand, the awareness of environmental protection is growing in the advertising industry. Therefore, it is a challenge to manufacture a fabric suitable for an inner light cloth of advertisements and having a whiteness that enhances the advertising effect while meeting environmental protection requirements.

### SUMMARY

The disclosure is directed to a fabric suitable for an inner light cloth of advertisements and a manufacturing method thereof, in which a whiteness that enhances the advertising effect is achieved while environmental protection requirements are met.

According to an embodiment of the disclosure, a fabric suitable for an inner light cloth of advertisements includes a yarn woven into the fabric with a whiteness of at least greater than 90%, in which the yarn is composed of fibers made from a white masterbatch.

In the fabric according to an embodiment of the disclosure, the white masterbatch includes a carrier resin and a white colorant.

In the fabric according to an embodiment of the disclosure, the carrier resin is not a polyvinyl chloride (PVC) resin.

According to an embodiment of the disclosure, a manufacturing method of a fabric suitable for an inner light cloth of advertisements includes the following. A yarn is provided, in which the yarn is composed of fibers made from a white masterbatch. A yarn dyeing process is carried out on the yarn to weave the fabric with a whiteness of at least greater than 90%.

In the manufacturing method of a fabric according to an embodiment of the disclosure, the whiteness is not obtained through a rinsing process.

In the manufacturing method of a fabric according to an embodiment of the disclosure, a water saving rate of the manufacturing method of a fabric is at least greater than 50% as compared with the rinsing process.

In the manufacturing method of a fabric according to an embodiment of the disclosure, the water saving rate of the manufacturing method of a fabric is greater than 65% as compared with the rinsing process.

In the manufacturing method of a fabric according to an embodiment of the disclosure, one or more chemicals are used in the rinsing process.

In the manufacturing method of a fabric according to an embodiment of the disclosure, the whiteness is not obtained through a calendering process or a coating process.

In the manufacturing method of a fabric according to an embodiment of the disclosure, producing the fibers includes the following. The white masterbatch including a carrier resin and a white colorant is provided. A weaving process, a knitting process, a non-knitting process or a tufting process is carried out.

Based on the above, the fabric of an embodiment of the disclosure includes a yarn woven into a fabric with a whiteness of at least greater than 90%, in which the yarn is composed of fibers made from a white masterbatch Accordingly, the fabric may achieve a whiteness that enhances the advertising effect while meeting environmental protection requirements.

### BRIEF DESCRIPTION OF THE DRAWING

The FIGURE is a schematic diagram of a change in chromatic aberration after UV exposure of an example and a comparative example.

### DETAILED DESCRIPTION OF DISCLOSED EMBODIMENTS

In order to clearly describe a fabric and a manufacturing method thereof of the disclosure, the disclosure will be described in detail by ways of embodiments.

The FIGURE is a schematic diagram of a change in chromatic aberration after UV exposure of an example and a comparative example.

According to an embodiment of the disclosure, a fabric suitable for an inner light cloth of advertisements includes a yarn woven into fabric with a whiteness of at least greater than 90%, in which the yarn is composed of fibers made from a white masterbatch. According to the aforementioned, the fabric of the embodiment of the disclosure may achieve a whiteness that enhances the advertising effect while meeting environmental protection requirements.

Furthermore, a manufacturing method of a fabric according to an embodiment of the disclosure includes the following. First, a yarn is provided, in which the yarn is composed of fibers made from a white masterbatch. Next, a yarn dyeing process is carried out on the yarn to weave a fabric with a whiteness of at least greater than 90%. That is, in an initial stage in the manufacture of the fabric of an embodiment of the disclosure, color development is performed on the corresponding fibers through addition of the white masterbatch, such that the whiteness of the fibers is increased (to at least greater than 90%). Next, the yarn made from the fibers is woven into the corresponding fabric by the yarn dyeing process. Thus, the fabric woven from the yarn may achieve the whiteness that enhances the advertising effect. In addition, since the whiteness of the fabric of the embodiment of the disclosure is obtained through the yarn dyeing process, rather than a rinsing process, a calendering process or a coating process, the environmental protection requirements can be met. However, the disclosure is not limited thereto.

Furthermore, producing the fibers of an embodiment of the disclosure at least includes the following. First, a white masterbatch including a carrier resin and a white colorant is provided. Next, a weaving process, a knitting process, a non-knitting process or a tufting process is carried out to obtain the aforementioned fibers. Since the aforementioned rinsing process uses, for example, one or more chemicals to achieve the whiteness through multiple treatments such as desizing, washing, bleaching, scouring, and dyeing, the rinsing process consumes a significant amount of energy and chemicals and is not environmental friendly. On the other hand, in the calendering process or coating process, for example, polyvinyl chloride resin is calendered or coated on the fabric to achieve the required whiteness. Since polyvinyl chloride is a “toxic plastic” with poor stability, a corresponding stabilizer is necessary to stabilize the properties of polyvinyl chloride. In addition, all life cycle stages of polyvinyl chloride, from raw material mining, manufacture, use, and to disposal, may cause harm to the environment and human health. Hence, the use of polyvinyl chloride resin may create a very adverse impact on the environment. The carrier resin of an embodiment of the disclosure may not be polyvinyl chloride resin, and the fabric may not have chemical residues. Thus, the fabric of an embodiment of the disclosure does not cause environmental problems such as those caused in a rinsing process, a calendering process, or a coating process, and may avoid the need to perform numerous procedures as in the rinsing process or the like. Therefore, the manufacturing process is simplified, and the manufacturing cost is reduced. However, the disclosure is not limited thereto.

In some embodiments, a water saving rate of the manufacturing method of a fabric of an embodiment of the disclosure is at least greater than 50% as compared with the rinsing process. Furthermore, the water saving rate of the manufacturing method of a fabric of an embodiment of the disclosure may be greater than 65% as compared with the rinsing process.

Hereinafter, the effects of the disclosure will be described in more detail with reference to Examples 1 to 2 and Comparative Examples 1 to 2.

### Example 1

A fabric (Moonlight River) manufactured by an embodiment (yarn dyeing process) of the disclosure was used.

### Example 2

An inner light cloth made of the fabric manufactured by Example 1 was used.

### Comparative Example 1

A fabric (Samba Backlit Textile) manufactured using a rinsing process was used.

### Comparative Example 2

An inner light cloth made of the fabric manufactured by Comparative Example 1 was used.

It should be noted that the composition and specification of the inner light cloth of which description is omitted herein will be readily understood by persons skilled in the art according to the content within the spirit and scope of the appended claims.

Example 1 and Comparative Example 1 were analyzed using a testing method defined in ISO 14046:2014, and the results are shown in Table 1. A conclusion is as follows. A water saving rate of Example 1 was 67.29% as compared with Comparative Example 1, which means that a good water saving effect can be achieved by using a fabric manufactured by the yarn dyeing process of an embodiment of the disclosure.

TABLE 1

| Fabric | Amount of water used (L) | Amount of water saved (L/m²) | Water saving rate |
|---|---|---|---|
| Example 1 | 39.38 | 81.02 | 67.29% |
| Comparative Example 1 | 120.4 | | |

In some embodiments, a fabric manufactured by the yarn dyeing process of an embodiment of the disclosure may reach a whiteness of 90.7% This whiteness is similar to the whiteness (98.2%) of a fabric manufactured by a rinsing process. A testing method defined in SB/T 10786-2012 is used. However, the disclosure is not limited thereto.

Example 1, Example 2, Comparative Example 1, and Comparative Example 2 were tested by an ultraviolet (UV) exposure method. The results are shown in Table 2, Table 3, and the FIGURE. A conclusion is as follows. After UV exposure, the whiteness obtained through the rinsing process exhibited a greater variation than the whiteness obtained from a masterbatch, and the fabric of Comparative Example 1 and the inner light cloth of Comparative Example 2 respectively exhibited a greater color change than the fabric of Example 1 and the inner light cloth of Example 2 of the disclosure, which means that the color obtained through the rinsing process was more unstable than that obtained from a masterbatch dyeing process. Furthermore, a carrier of a dedicated masterbatch is of the same type of plastic of a product, and a good match is achieved. Pigment particles after heating and melting can be well dispersed in the plastic product. Therefore, the masterbatch has relatively good dispersibility. In the case of directly using a pigment in plastic processing, the pigment may be in direct contact with the air during storage and use and may absorb moisture and oxidize. In the case of a masterbatch, a resin carrier may isolate a pigment from the air and moisture, such that the chemical stability of the pigment can be maintained for a long time. Thus, the stability of chemical pigments and colors can be maintained.

Furthermore, according to the results shown in Table 2 and the FIGURE, after UV exposure, both the fabric of Comparative Example 1 and the inner light cloth of Comparative Example 2 exhibited a greater difference in chromatic aberration than the fabric of Example 1 and Example 2 of the disclosure. Therefore, the rinsing process exhibited less color stability than the masterbatch. The chromatic aberration in Table 1 was calculated by formula (1), in which ΔL=L sample-L standard (lightness aberration), Δa=a sample-a standard (red/green aberration), and Δb=b sample-b standard (yellow/blue aberration).

TABLE 2

| | Example 1 | Example 2 | Comparative Example 2 | Comparative Example 1 |
|---|---|---|---|---|
| | ΔE | ΔE | ΔE | ΔE |
| 24 hours | 1.56 | 5.74 | 10.33 | 11.42 |
| 48 hours | 3.32 | 7.16 | 12.91 | 14.36 |
| 144 hours | 6.44 | 10.53 | 17.28 | 17.55 |
| 168 hours | 6.57 | 12.2 | 17.69 | 17.94 |

$$\text{Δ} {\text{E}}_{\text{ab}} {}^{∗} = {\left[{\left(\text{Δ} {\text{L}}^{∗}\right)}^{2} + {\left(\text{Δ} {\text{a}}^{∗}\right)}^{2} + {\left(\text{Δ} {\text{b}}^{∗}\right)}^{2}\right]}^{1 / 2}$$

TABLE 3

| | Whiteness test 1 | Whiteness test 2 | Average | Difference |
|---|---|---|---|---|
| Comparative Example 1 before UV exposure | 89.29 | 89.25 | 89.3 | Standard |
| Comparative Example 1 after UV exposure | 86.93 | 86.95 | 86.9 | 2.7% |
| Comparative Example 2 after UV exposure | 85.73 | 85.76 | 85.7 | 4% |
| Example 1 before UV exposure | 85.58 | 85.54 | 85.6 | Standard |
| Example 1 after UV exposure | 85.59 | 85.65 | 85.6 | 0 |
| Example 2 after UV exposure | 85.79 | 85.8 | 85.8 | 0.02% |

In some embodiments, the white colorant may be uniformly adhered on a carrier resin, in which the carrier resin may be any suitable resin other than a polyvinyl chloride resin. In addition, the white masterbatch may include a suitable additive according to actual design requirements.

In some embodiments, after the fabric of an embodiment of the disclosure is manufactured, the fabric may be subjected to a laminating process, a calendering process, a knife scraping process, a coating process, a bonding process, or a combination thereof to achieve a spray painting effect desired on the inner light cloth of advertisements. However, the disclosure is not limited thereto.

It should be noted that the disclosure is not limited to the aspects described in the above, nor is it limited to the parameters (such as mesh density, light transmittance, thickness, count or other fabric parameters) of the fabric. Any fabric suitable for an inner light cloth of advertisements that is manufactured by a yarn dyeing process and has a whiteness of at least greater than 90% falls within the scope of the disclosure.

To sum up, the fabric of an embodiment of the disclosure includes a yarn woven into the fabric with a whiteness of at least greater than 90%, in which the yarn is composed of fibers made from a white masterbatch. Accordingly, the fabric may achieve a whiteness that enhances the advertising effect while meeting environmental protection requirements. In addition, the carrier resin of an embodiment of the disclosure may not be polyvinyl chloride resin, and the fabric may not have chemical residues. Accordingly, the fabric of an embodiment of the disclosure does not cause environmental problems such as those caused in a rinsing process, a calendering process, or a coating process, and may avoid the need to perform numerous procedures as in the rinsing process or the like. Therefore, the manufacturing process is simplified, and the manufacturing cost is reduced.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A fabric suitable for an inner light cloth of advertisements, comprising:
a yarn, woven into the fabric with a whiteness of at least greater than 90%, wherein the yarn is composed of fibers made from a white masterbatch.

2. The fabric according to claim 1, wherein the white masterbatch comprises a carrier resin and a white colorant.

3. The fabric according to claim 2, wherein the carrier resin is not a polyvinyl chloride resin.

4. A manufacturing method of a fabric suitable for an inner light cloth of advertisements, comprising:
providing a yarn, wherein the yarn is composed of fibers made from a white masterbatch; and
carrying out a yarn dyeing process on the yarn to weave the fabric with a whiteness of at least greater than 90%.

5. The manufacturing method of a fabric according to claim 4, wherein the whiteness is not obtained through a rinsing process.

6. The manufacturing method of a fabric according to claim 5, wherein a water saving rate of the manufacturing method of a fabric is at least greater than 50% as compared with the rinsing process.

7. The manufacturing method of a fabric according to claim 6, wherein the water saving rate of the manufacturing method of a fabric is greater than 65% as compared with the rinsing process.

8. The manufacturing method of a fabric according to claim 5, wherein one or more chemicals are used in the rinsing process.

9. The manufacturing method of a fabric according to claim 4, wherein the whiteness is not obtained through a calendering process or a coating process.

10. The manufacturing method of a fabric according to claim 4, wherein producing the fibers comprises:
providing the white masterbatch comprising a carrier resin and a white colorant; and
carrying out a weaving process, a knitting process, a non-knitting process or a tufting process.
